(19) United States
(12) Patent Application Publication
(10) Pub. No.: US 2023/0131380 A1
(43) Pub. Date: Apr. 27, 2023

(54) Apparel to be Associated with a Digital Asset with Associated Methods

(71) Applicant: Iddris Sandu, Los Angeles, CA (US)

(72) Inventor: Iddris Sandu, Los Angeles, CA (US)

(21) Appl. No.: 17/509,329

(22) Filed: Oct. 25, 2021

(51) Int. Cl. G06Q 30/00; G06Q 50/00; G06Q 50/26; G06Q 20/12; G06Q 20/36; G06Q 30/06; G06K 19/073

(52) U.S. Cl. CPC G06Q 30/0185; G06Q 50/01; G06Q 50/265; G06Q 20/123; G06Q 20/367; G06Q 30/0601; G06K 19/07309; G06K 19/0723

(57) ABSTRACT

A method for associating a digital asset to apparel and said apparel to a user, where the apparel includes an embedded chip that is assigned a blockchain ID. The user utilizes a mobile device to create an account for linking the asset to the user and scans the apparel with the mobile device. During the scan by the mobile device the mobile device detects the presence of the embedded chip and further detects the chip ID. This chip ID is transmitted to a server, where the server validates the chip ID and transmits a confirmation of the authenticity of the chip ID to the mobile device. Upon receipt of the confirmation by the mobile device the apparel is determined to be authentic. Authenticated apparel can be logged to a user account.

### FIELD OF THE INVENTION

The present invention relates generally to authenticating apparel that includes an embedded chip. The apparel may be scanned by the user using a mobile device which confirms the authenticity of the apparel. Generally, the chip enables a digital asset to be associated with the apparel.

### BACKGROUND OF THE INVENTION

In today's world, new apparel is ubiquitous and new clothing brands are being formed at a high pace. With the proliferation of these various clothing lines, counterfeiting is a prolific problem. It is difficult for a company to produce items that are of an excellent quality and in demand, only to have those same items copied and sold. Counterfeiting is an inhibitor to industry volume growth. It distorts brand loyalty, destroys brand equity, and results in revenue losses. Therefore, there is a need for apparel that can be authenticated by the user, so that the user can avoid purchasing counterfeit goods.

Proposed solutions to the problem referenced above do not go far enough in enabling the attachment of value to apparel. Merely branding the apparel is not enough because counterfeit clothes will include inappropriate branding as well, which confuses consumers. Clothes are an expression of a wearer's lifestyle, and their culture. Creatives can tap into the ethos of their intended market and attach value to their apparel to make their creations more marketable.

Therefore, it is desirable to create apparel that can resist the efforts of counterfeiters, while enabling creators to attach value to their apparel. The system and associated method, described herein, will provide a solution to the shortcomings of the industry as detailed above.

### SUMMARY OF THE INVENTION

The present invention advantageously fills the aforementioned deficiencies by providing a system and method for associating a digital asset with apparel. The invention allows a user to attach assets to apparel. This is particularly useful as an asset may be media or digital content. The owner of the apparel may be granted access to that digital asset. It is designed to assist the creators of this apparel in creating an experience for the user. The digital asset that is attached to the apparel may be an exclusive song or a video or access to exclusive footage or photographs of the user's favorite celebrity.

Attaching these assets to the apparel, makes the apparel more valuable. Apparel that includes an ability to access exclusive content becomes more valuable to the user. Creators can use this ability to attach content that would attract certain users. For example, a shoe that features exclusive content from Beyoncé would be an exciting offering for fans of Beyoncé. Similarly a shirt that features exclusive content from J Cole would be an interesting offering for fans of J Cole. Different embodiments of the invention will illustrate that the users will not only be able to experience the exclusive content due to their purchase of the apparel, but the user will also be able to confirm the authenticity of the apparel and further determine previous owners of the apparel.

In a preferred embodiment of the invention, the method for associating a digital asset to apparel and said apparel to a user, where the apparel includes an embedded chip that is assigned a blockchain ID, and where a mobile device is used to create an account for linking the asset to the user comprises scanning the apparel with a mobile device, wherein the mobile detects the presence of the embedded chip and further detects the chip ID of the chip; and transmitting the detected chip ID to a server wherein the server is configured to validate the chip ID and transmits a confirmation of the authenticity of the chip ID to the mobile device. The mobile device receives the confirmation from the server, which indicates that the apparel is authentic. The method further comprises associating the detected chip ID of the chip with the user's account, and determining the digital asset associated with the detected chip ID and associating the digital asset with the user's account.

The user is able to see the confirmation of the authenticity of the chip on the mobile device, which is indicative of the authenticity of the apparel. Additionally, the user is able to create an account on the mobile device which associates the detected chip ID with the user's account.

In another embodiment of the invention, the digital asset associated with the chip is determined during the scan of the apparel by the mobile device, where the embedded chip transmits the digital asset to the mobile device.

The embedded chip may also include a digital asset or a link to a digital asset that can be stored to the user's account so that the user can access the digital asset at their convenience. In another embodiment of the invention, associating the digital asset with the user may further entail associating the digital asset with a social media account of the user, or may further entail associating the digital asset with a state-issued or national identification of the user. These various mechanisms for associating the digital asset with the user may provide additional security which can be necessary depending on the value of the asset that has been embedded in the apparel. For instance, a Non Fungible Token (NFT) may be included in the embedded chip with a value that is significant to the user. In such an instance, associating ownership of the NFT with a social media account or national ID of the user may prove valuable because it acts as a deterrent for would-be thieves and hackers etc.

In another embodiment of the invention, the digital asset associated with the embedded chip may be determined during the scan of the apparel by the mobile device, where the embedded chip transmits the digital asset to the mobile device.

In a preferred embodiment of the invention, the user utilizes the mobile device to access the digital asset linked to the apparel. This makes it very convenient for the user to access the digital asset. The user that will purchase apparel with an embedded chip is likely to use his/her/their mobile device frequently throughout the course of their day. Therefore, the ability to access their favorite exclusive digital assets at their fingertips would be an advantage.

In another embodiment of the invention, the chip embedded in the apparel may include 2 chips, a primary chip and a secondary chip. The primary chip may include data that is not changeable. The secondary chip may include data that can be changed, or erased as necessary. During a scan of apparel belonging to a user, both the primary and secondary chips may transmit signals to the mobile device performing the scan. In an embodiment of the invention, the scan may determine that the apparel is damaged if a signal from at least one of the primary or the secondary chip is not received by the mobile device.

In an embodiment of the invention, the user may utilize their mobile device via their account to delete the digital asset from the secondary chip. In another embodiment of the invention, the secondary chip may include a codec for content wherein the codec may be written and overwritten, and wherein the primary chip may be used for identification purposes and cannot be overwritten or edited. In a further embodiment, only an authorized user may be able to overwrite or edit the digital asset in the secondary chip. An authorized user may be a user with access and privilege rights to overwrite or delete the digital asset from the secondary chip.

In a further embodiment of the invention, the secondary chip may be preloaded with the digital asset. For example, depending on the requirements of the creators, it may be advantageous to ship 10000 pairs of shoes where 100 pairs of those shoes are preloaded with exclusive content that is available to the user upon purchase. Conversely, a creator may want to use a different marketing strategy where the shoes are not shipped with the asset preloaded and give access to exclusive content on a particular time and date, where the digital asset is made available at a time after purchase of the apparel.

Another embodiment of the invention may enable the mobile device to delete the digital asset from the apparel by overwriting the secondary chip with a null value upon a prompt from the user. A further embodiment of the invention includes an embedded chip that may be security enabled. The security enabled chip may not be interfered with or changed, and may be very difficult to remove from the apparel without damaging the chip's structure, which would render the chip inoperable. In a further embodiment of the invention, a user may utilize their mobile device to perform an authorized over-the-air update of the secondary chip.

The present invention now will be described more fully hereinafter with reference to the accompanying drawings, which are intended to be read in conjunction with both this summary, the detailed description and any preferred and/or particular embodiments specifically discussed or otherwise disclosed. This invention may, however, be embodied in many different forms and should not be construed as limited to the embodiments set forth herein; rather, these embodiments are provided by way of illustration only and so that this disclosure will be thorough, complete and will fully convey the full scope of the invention to those skilled in the art.

### BRIEF DESCRIPTION OF THE DRAWINGS

FIG. 1 is a schematic of one embodiment of the system of the present invention.

FIG. 2 is a flow diagram illustrating a process for associating a digital asset with apparel in accordance with an exemplary embodiment of the invention.

FIG. 3 is a flow diagram illustrating a process trading digital assets in accordance with an exemplary embodiment of the invention.

FIG. 4 is a flow diagram illustrating a process for tracking missing digital assets in accordance with an exemplary embodiment of the invention.

FIG. 5 is a flow diagram illustrating a process for responding to scanning a missing digital asset in accordance with an exemplary embodiment of the invention.

FIG. 6 is an illustration of a representative graphical user interface of a mobile device displaying a stock ticker as an exemplary embodiment of the invention.

FIG. 7 is an illustration of a representative graphical user interface of a mobile device which displays apparel, stock price for the apparel's brand, the ability to update firmware and the option to trade the digital asset and/or apparel that is displayed.

FIG. 8 is an illustration of using a mobile device and accessing a digital asset. The apparel, its stock price and the number of taps received for that digital asset are also displayed.

FIG. 9 is an illustration of an item of apparel with an embedded chip.

### DETAILED DESCRIPTION

This disclosure is capable of embodiments in many different forms. Representative examples of the disclosure are shown in the drawings and will be described in detail herein with the understanding that these representative examples are provided as an exemplification of the disclosed principles, not limitations of the broad aspects of the disclosure. To that extent, elements and limitations that are described in the Abstract, Technical Field, Background, Summary, and Detailed Description sections, but not explicitly set forth in the claims, should not be incorporated into the claims, singly or collectively, by implication, inference or otherwise.

For purposes of the present detailed description, unless specifically disclaimed: the singular includes the plural and vice versa; the words “and” and “or” shall be both conjunctive and disjunctive; the words “any” and “all” shall both mean “any and all”; and the words “including,” “comprising,” “having,” “containing,” and the like shall each mean “including without limitation.” Moreover, words of approximation, such as “about,” “almost,” “substantially,” “approximately,” and the like, may be used herein in the sense of “at, near, or nearly at,” or “within 0-5% of,” or “within acceptable manufacturing tolerances,” or any logical combination thereof, for example.

The present invention advantageously fills the aforementioned deficiencies by providing a system and method for associating a digital asset with apparel. One of ordinary skill in the art will appreciate that a digital asset may include, but is not limited to photography, illustrations, animations, logos, audiovisual media, presentations, spreadsheets, word documents, electronic mails, websites, digital paintings, and numerous other digital formats and their respective metadata. Further, a digital asset may be a ticket or a right to access a show or stream or performance. A digital asset is anything that exists in a digital format and comes with the right to use. Apparel may include, but is not limited to shirts, pants, shoes and any article of clothing that covers a part of the body. In this disclosure, apparel may also be referred to as an apparel item or an item of apparel. Additional embodiments of the invention will demonstrate that the application of this invention is not limited to apparel and may be utilized anywhere a chip, as described in this invention, may be embedded, such as consumer goods.

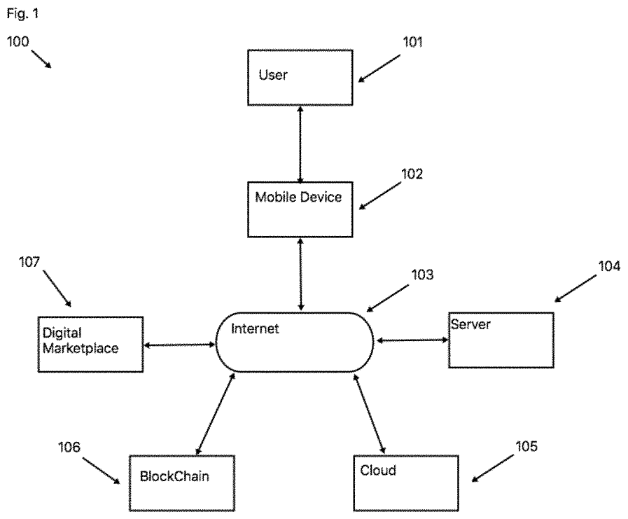

Referring to FIG. 1, an embodiment of the system 100 of the present invention is shown. System 100 functions to (a) validate apparel, (b) provide access to digital assets, (c) provide a marketplace where digital assets may be sold or traded between users of the digital marketplace platform and (d) prevent theft. System 100, may comprise a user 101, the user's mobile device 102, the internet 103, the server 104, the cloud 105, the blockchain 106 and the digital marketplace 107. The mobile device 102 may be operatively connected to the internet 103 and may be used to validate apparel, provide access to digital assets, buy, sell and/or trade any available digital assets, via the server 104, which is also connected to the internet 103. One of ordinary skill in the art will appreciate that the Internet is not the sole means of connecting the different elements of System 100. It can be envisioned that any network such as a global communications network that enables or facilitates connectivity among the elements would suffice for the operation of this invention. The server may also be connected to the cloud 105, which facilitates storage of digital assets, account information and the like. Internet 103 may be the vast network known as the Internet that connects computers all over the world.

The elements above are discussed in greater detail below. It should be understood, however, by a person having ordinary skill in the art, that the schematic of FIG. 1 is provided for illustrative purposes only, and the system and process of the present invention may be practiced in ways not specifically shown in FIG. 1. The server 104 may be further distributed among multiple servers. Therefore, the schematic of system 100 should not be used to limit the structure of the system more narrowly than the claims.

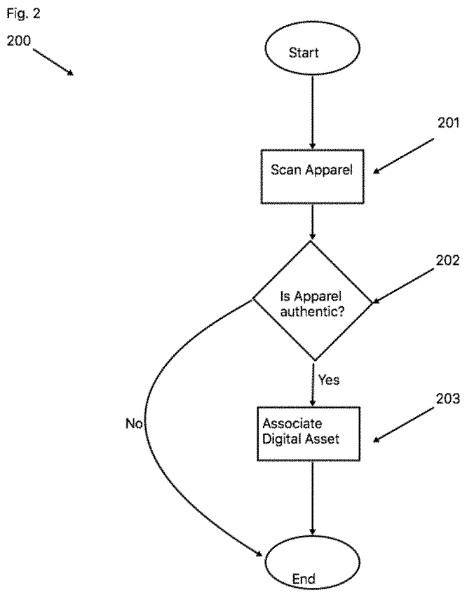

Referring to FIG. 2, the method 200 of using system 100 is described. At 201, the user 101 may scan their apparel with their mobile device 102. The apparel may contain an embedded chip that may be assigned a blockchain ID. When the apparel is scanned, the mobile device 102 may detect the presence of the embedded chip and may further detect the chip ID of the chip. The chip ID may be transmitted via the internet 103 to server 104. At 202, the server 104 may be configured to validate or verify the chip ID of the chip by comparing the chip ID to the entries in the blockchain 106. If the chip ID matches an entry in the blockchain, server 104 may transmit a confirmation of the authenticity of the apparel to mobile device 102. At step 203, after the apparel's authenticity is verified, the server 104 may associate the chip ID of the apparel with the user 101, determine the digital asset associated with the chip ID and associate the digital asset with the account of user 101. Mobile device 102 may be used by the user to create an account for linking the digital asset to the user. Account creation may include allowing user 101 to enter their preferred username, password and email address. Account creation may further include, but is not limited to, collecting user identifying information such as their name, address and date of birth and social media account information and the like. A user may be assigned an account ID after successfully creating an account which uniquely identifies each user account.

Server 104 may determine the digital asset associated with the chip ID by looking up the chip ID in Blockchain 106. The blockchain entry for that chip ID may include the associated digital asset, additionally server 104 may store identifying information of user 101, such as an account ID in the same blockchain entry. In a further embodiment, the digital asset associated with the chip may be determined during the scan of the apparel by the mobile device, where the embedded chip transmits the digital asset to the mobile device after server 104 confirms the authenticity of the apparel.

In a separate embodiment of the invention, at step 203, after the apparel's authenticity is verified, server 104 may also associate an asset creator with user 101. The asset creator may be the person or entity that owns the brand that incorporated digital assets into their products. Asset creators may also have an account ID assigned to them after an initial sign up process. Therefore, when user 101 purchases or obtains an item which includes a digital asset, server 104 may also associate user 101 with the asset creator by associating the account ID of the user with the asset creator. When the asset creator uploads or updates content or launches a new product, user 101 may receive a notification because of their association with the asset creator. The asset creator may decide how notifications are deployed to associated users. For example, a notification for a new product may be deployed to all associated users or only users that have acquired certain digital assets, or users that have acquired certain apparel. Similarly, new or updated content may be deployed to all associated users or only users that have acquired certain digital assets.

In a preferred embodiment of the invention, associating the detected chip ID of the chip with the account of user 101 may include associating the chip ID with a social media account of the user. Social media accounts means any websites, applications and similar electronic means by which users are able to create and share information, ideas, personal messages, and other content (including, without limitation, text, photos and videos) or to participate in social networking, such as, but not limited to facebook, instagram, twitter and the like. In another embodiment of the invention, associating the detected chip ID of the chip with the user's account may include associating the chip ID with a state-issued identification of the user. A state-issued identification may be substituted with a passport or driver's licence or any type of identification deemed suitable enough for identifying a user that is difficult to forge or counterfeit.

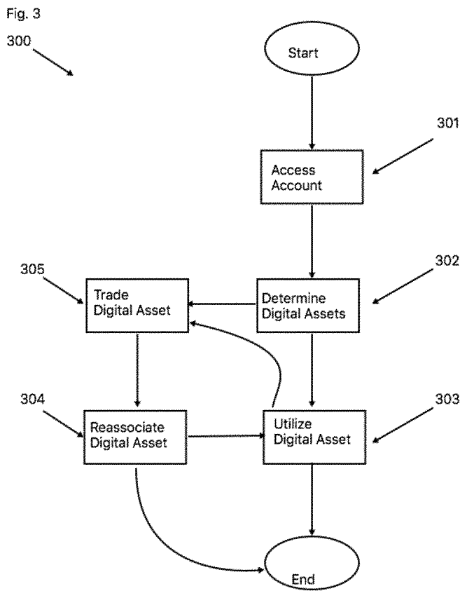

Referring to FIG. 3, the method 300 of using the system 100 is described. At 301, user 101 may utilize or use their mobile device 102 to access their account on server 104. Once their account is successfully accessed, the mobile device may determine the user's digital assets at step 302. Determining the user's assets, stated alternatively, is the process of identifying what digital assets may belong to user 101. Server 104 may determine what digital assets belong to user 101 by determining the various digital assets that are associated with the account ID of user 101. After said determination, user 101 may opt to access or utilize their digital assets at step 303 on their mobile device 102 or visit the digital marketplace 107 to trade their digital asset at step 305. Accessing or utilizing a digital asset may entail playing or viewing or editing their digital asset and the like. As added protection for the asset creator, a user may be able to access the digital asset without accessing the original source code or source file. For example, if the digital asset is a music file, the user is able to access, stream and play the music, however, the music file is never made available to the user.

While accessing or utilizing said digital asset, user 101 may be able to view a stock ticker that includes various metrics about the digital asset. Trading a digital asset at step 305 may entail user 101 selling one or more of their digital assets or acquiring one or more digital assets belonging to a third party that is offered for sale on the digital marketplace 107. If a digital asset is traded on digital marketplace 107, said asset may have to be reassociated at step 304, where the server 104 updates an entry in blockchain 106 to reflect new ownership of the digital asset.

In an embodiment of the invention, the chip embedded in the apparel may include 2 chips, a primary chip and a secondary chip. The primary chip may include data that is not changeable. The secondary chip may include data that can be changed, or erased as necessary. The primary chip may include a chip identifier or chip ID, that is permanent. The data held in the primary chip may be immutable and may enable the creation of a permanent link between the embedded chip and the blockchain. During a scan, mobile device 102 may determine the apparel is damaged when the mobile device does not detect a signal from at least one of the primary chip and the secondary chip. Once the primary chip is not damaged, mobile device 102 may always be able to scan the embedded chip to determine ownership of the apparel that contains the embedded chip and the digital asset associated with said embedded chip.

In an embodiment of the invention, the data held in the secondary chip may be a preloaded digital asset or a pointer to the digital asset. When the secondary chip holds the digital asset, this asset may be detected upon a scan of the apparel by user 101, using mobile device 102. The detected digital asset may be logged with server 104, which connects to mobile device 102 via internet 103. The detected digital asset may be logged under the account of user 101 so that user 101 may access their digital asset at their convenience. In a separate embodiment, the digital asset may include data that allows said asset to be accessible after a certain time or date by user 101.

When the secondary chip holds a pointer to the digital asset, the pointer may point to a blockchain address where the asset is stored. The blockchain address may contain a digital asset that is detected upon a scan of the apparel, or the blockchain address may contain a null value—where the digital asset may be made available at a later time or date as determined by the asset creator—the owner of the apparel's brand. For example, a number of limited edition shoes may be launched where the digital asset is a video that can only be accessed by purchasers of the shoe at midnight of a chosen day. This type of release could serve to drum up interest in the shoes. In an embodiment of the invention, the blockchain address may be updated with a digital asset at a particular date and time to coincide with the launch of a product and the users that have access to the digital asset may receive notifications indicating that the digital asset has been uploaded and ready to be accessed. In a separate embodiment, the users may receive notifications prior to the upload, alerting the users of the impending upload.

During a scan of apparel belonging to a user, both the primary chip and the secondary chip may transmit signals to the mobile device performing the scan. In an embodiment of the invention, the scan may determine that the apparel is damaged if a signal from at least one of the primary chip and the secondary chip is not received by the mobile device.

In an embodiment of the invention, user 101 may use or utilize their mobile device 102 to delete the digital asset from the secondary chip. When user 101 deletes the digital asset from the embedded chip in the apparel, server 104, may reassociate the block chain so that the digital asset does not have an owner or an account to which it is assigned. In another embodiment, mobile device 102, upon a prompt from the user 101 may delete the digital asset from the apparel by overwriting the secondary chip with a null value.

In another embodiment of the invention, the secondary chip may include a codec for content wherein the codec may be written and overwritten, and wherein the primary chip is used for identification purposes and cannot be overwritten or edited. In a further embodiment, only an authorized user may be able to overwrite or edit the digital asset in the secondary chip. In another embodiment of the invention, the primary chip may contain the chip identifier or chip ID and the secondary chip may contain one or more digital assets. In an embodiment, an authorized user may be an asset creator.

In another embodiment of the invention, the embedded chip may be security enabled. The security enabled chip may not be interfered with or changed, and may be very difficult to remove from the apparel without damaging the chip's structure, which would render the chip inoperable. The embedded chip may be comprised of a primary chip and a secondary chip and may be a very sturdy chip and small in size, however, an attempt to remove the embedded chip from the apparel may damage the apparel and make it unsuitable to wear. Additionally, an attempt to remove the embedded chip may damage the embedded chip itself. During a scan of apparel by mobile device 102, the apparel may be labeled as damaged if the scan does not detect signals from at least one of the primary chip and secondary chip.

In an embodiment of the invention, the secondary chip may be updated by mobile device 102 performing an authorized over-the-air update. An over-the-air update may be the wireless delivery of new software, firmware or other data. In an embodiment of the invention, an over-the-air update may enable user 101 to use their mobile device 102 to update the secondary chip, where said update is received via internet 103 from server 104. An update may include editing, changing or updating the data held by the secondary chip.

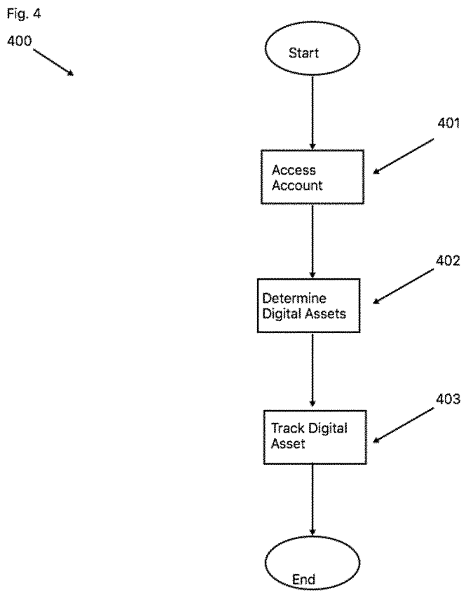

Referring to FIG. 4, the method 400 of using system 100 is described. At 401, user 101, may access their user account with their mobile device 102. At step 402, user 101 may determine their digital assets. At step 403, user 101 may use mobile device 102 to track their digital assets. Tracking a digital asset may involve labeling the asset as missing or lost. When user 101 labels an asset as lost, mobile device 102, may update server 104 via internet 103. User 101 may choose different actions to be performed if the apparel containing the digital asset labeled as lost is scanned. These actions may include notifying user 101 that the asset has been located and providing the information of the 3rd party that scanned the apparel. Additional actions that may occur upon scanning apparel that contains said lost digital asset may also include (1) logging the location information where the digital asset was scanned, (2) providing information to the 3rd party so that the digital asset can be returned, (3) deleting the digital asset from the apparel, and/or (4) sending a direct message or ping to the owner of the asset—user 101—indicating that the asset has been located or that the asset has been scanned by a third party user. The message may also include the name of the third party user that scanned the digital asset. These actions that may occur upon scanning apparel, may occur automatically without intervention by the 3rd party. Alternatively, the 3rd party user may be prompted before the action is completed.

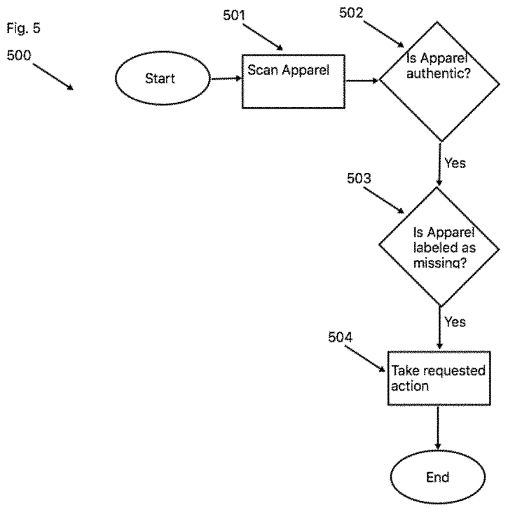

Referring to FIG. 5, the method 500 of using system 100 is described. At step 502, the authenticity of the apparel is determined. For authentic apparel, step 503 performs another check to determine if the apparel is labeled as missing or lost. If the apparel is labeled as missing, various actions may occur as determined by user 101, who reported the apparel as missing. At step 504, for apparel labeled as missing or lost, the following actions may occur—server 104 may (1) detect and report the location information where the digital asset was scanned, (2) provide information to the 3rd party so that the digital asset can be returned, and/or (3) delete the digital asset from the apparel. The action taken by server 104 upon detecting apparel labeled as missing are the actions chosen by user 101 when said user labeled the apparel as missing.

In a further embodiment of the invention, user 101 may opt to sell their digital asset to a 3rd party. In this embodiment, the mobile device 102 may transmit the chip ID to server 104, and further transmit an indication to register the digital asset to a third party, and may further transmit the account ID of the 3rd party to said server. Server 104 may reassociate the detected chip ID of the chip to the 3rd party account by removing the association of the chip ID with user 101 in blockchain 106 and associating the chip ID with the account ID of the 3rd party and may further associate the digital asset with the 3rd party account ID. In an alternative embodiment of the invention, user 101's digital asset may be an access certificate such as a ticket that provides access to a show or live performance. User 101 may opt to sell that ticket without selling the underlying digital asset. In a transaction that involves the sale of that ticket, server 104, would reassociate the owner of the ticket to indicate that the owner of the ticket is a 3rd party by associating the ticket with an account ID of said 3rd party that purchases the ticket while user 101 maintains ownership of the digital asset.

In a further embodiment of the invention, user 101 may opt to share their digital asset with another user. User 101 may use their mobile device 102 to share one or more of their acquired digital assets, where server 104, grants access to a 3rd party to view and access one or more digital assets. The parameters of how a share may occur are determined by the asset creators or the initial/original entity selling the apparel that contains the embedded chip that contains the digital asset. Sharing a digital asset with a 3rd party may deprive user 101 of the ability to interact with said digital asset until the 3rd party interacts with the shared digital asset. The 3rd party may be given a number of times to interact with the shared digital asset or may be given a certain amount of time to interact with the shared digital asset. Additionally, the 3rd party may be enabled to share the digital asset with a separate user. User 101 may also have the ability to cancel the share of the digital asset so that access to the digital asset is returned to them. In a further embodiment of the invention, user 101 may share digital content with a third party via a QR code. User 101 may generate a QR code by using mobile device 102 where the QR code enables a 3rd party to access a digital asset. A generated QR code may provide a single access to the digital asset. After the QR code is used by the 3rd party once, it will no longer redirect a 3rd party to access the digital asset. In another embodiment of the invention, a 3rd party user may be allowed to access the digital asset more than once. The generated QR code may enable access by generating a pointer to the digital asset. After the single use, the QR code may provide the third party user with an opportunity to purchase apparel that contains said digital asset.

In a further embodiment, system 100 may be used to provide an electronic marketplace for viewing, buying and selling digital assets. In one embodiment, user 101 may use a digital wallet contained on mobile device 102 to access digital marketplace 107 via internet 103. The digital marketplace 107 may allow users to view, buy and sell digital assets. The digital wallet may store these assets which may be linked to user 101. In one embodiment, these digital assets may be in an embedded chip in apparel, however, the digital marketplace may also house digital assets that are not linked to apparel that are available for purchase. Server 104 may be programmed to receive over a computing network, such as internet 103, a repository of digital assets owned by the user 101 that may be stored in the digital wallet on mobile device 102, where each digital asset may be associated with a user account associated with the user 101 and the apparel into which the digital asset is integrated. User 101 may be further presented with an option to broadcast the digital asset for sale on the digital marketplace 107.

System 100, may also enable user 101 to sell the digital asset attached to the apparel separately from the apparel on the marketplace. In this instance, a 3rd party may purchase the digital asset on digital marketplace 107. When a 3rd party purchases a digital asset, server 104 may reassociate the digital asset with user 101 which entails removing the association of the digital asset and user 101 account ID in the blockchain 106 and associating said digital asset with the account ID of the purchasing 3rd party in blockchain 106.

User 101 may also opt to sell the apparel with the digital asset on the digital marketplace 107. In this instance, when a 3rd party purchases the apparel, server 104 may reassociate the chip ID of the embedded chip with user 101 which entails removing the association of the chip ID and user 101 account ID in the blockchain 106 and associating the chip ID with the account ID of the purchasing 3rd party in blockchain 106. In a separate embodiment of the invention, user 101 may utilize mobile device 102 to instruct server 104 to reset the blockchain entry so that the chip ID of the embedded chip is not linked to user 101 account ID. Therefore, upon purchase of the apparel, the 3rd party may scan the embedded chip and associate the apparel and digital asset with their own account ID on the blockchain. In a further embodiment of the invention, the 3rd party may purchase a digital asset from the marketplace and upload the purchased digital asset to an item of apparel.

In a further embodiment of the invention, user 101 may be granted administrative access and use mobile device 102 to access a master dashboard on server 104. A user with administrative access may be an asset creator. With administrative access, user 101 may view, edit or delete the digital assets that are associated with apparel. User 101 may use mobile device 102 to change the digital asset that can be accessed by users that own the apparel. When user 101 makes a change to the digital asset, server 104 immediately updates the digital asset for all of the users that have access to said digital asset. This change may occur in real time while a user is accessing the digital asset. For example, a user that is streaming a digital asset, would have that streaming experience interrupted and seamlessly provided with the option to access the new digital asset that has been rolled out. Server 104 may also include additional metrics in the master dashboard so that user 101 can determine the level of engagement users have had with the digital assets. These metrics may include but is not limited to the following: (a) how many times has the digital asset been viewed, (b) how many times the asset has been sold or traded, (c) how many times the digital asset has been shared and (d) how many times the asset has been scanned or tapped. Taps may be defined as a recommend button or a like button where a user may “tap” to indicate their preference or express their approval of a digital asset. In a further embodiment of the invention, the apparel may be launched where the embedded chip's secondary chip contains a pointer to a digital asset that is not yet uploaded, and the blockchain address for the digital asset may contain a null value. User 101 may use the master dashboard via their mobile device 102 to upload or push or roll out a digital asset to the users that have access to said digital asset where the blockchain address on blockchain 106 for the digital asset may be updated by server 104 via internet 103 with the digital asset selected by user 101. This feature is useful when an item of apparel is shipped without a preloaded digital asset, user 101 may use the master dashboard via their mobile device to upload a digital asset to the users that purchased the item of apparel.

In a further embodiment, practitioners of ordinary skill in the art would appreciate that this invention can be practiced without the blockchain (106) as illustrated in FIG. 1. In this embodiment, a combination of server 104 and cloud 105, would perform the functions normally performed by blockchain as described above.

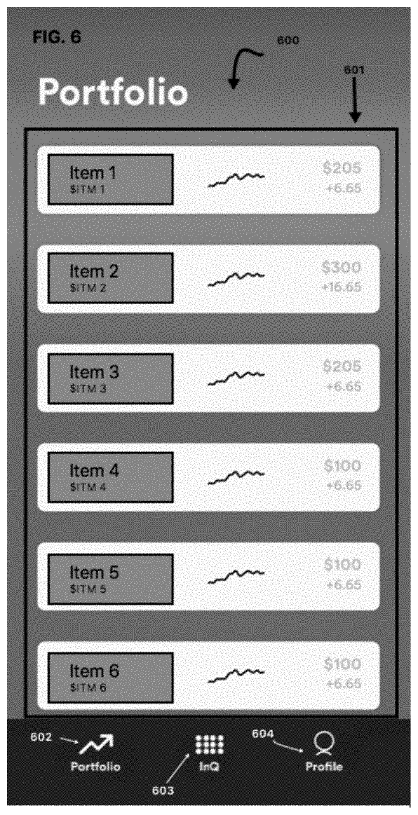

Referring to FIG. 6, 600 illustrates an embodiment of the present invention which includes a stock ticker 601 and 3 buttons 602, 603 and 604. The stock ticker may be viewed when the user presses portfolio button 602. The various brands associated with the apparel purchased by user 101 comprise the portfolio of the user 101. The stock ticker includes the purchased apparel, the symbol for the apparel's brand, the current price of the apparel's brand's stock and an indication of whether or not the price of the stock has risen or dropped in the relative time period. LNQ button 603 may take user 101 to a home screen where the user can view the apparel purchased and the associated digital assets. Profile button 604 may take user 101 to their profile page where the user can edit basic information about their account, change their preferences and the like.

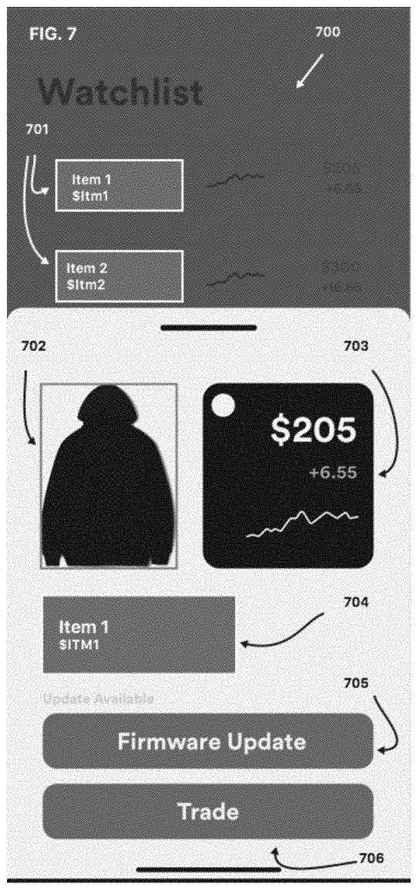

Referring to FIG. 7, 700 illustrates a representative graphical user interface of a mobile device which displays a watchlist for apparel, stock price for the apparel's brand, the ability to update firmware and the option to trade the digital asset and/or apparel that is displayed. The watchlist may display apparel that the user is interested in purchasing. In FIG. 7, element 701 may display item 1 and item 2 which are on the user's watchlist. When the user selects an item, said item may be highlighted. In this figure, the user has highlighted item 1 which may enable elements 702-706 to be displayed on the screen. In this example, element 702 is a hoodie with a price as indicated by element 703 of $205. Element 703 also indicates that the price of Item 1 has increased by $6.55. One of ordinary skill in the art will understand that FIG. 7 is merely an example of an embodiment of the invention. 700 may display multiple items on the user's watchlist. The items that a user may place on their watchlist are not limited to hoodies. Any item that is available in the marketplace may be placed on the user's watchlist. The price of a selected item is determined by an algorithm which calculates the value of the item based on an index that takes the cost and the content value into consideration in determining the final price of the item. The number of taps for a selected item may also factor into the price consideration indicated. Element 704 may highlight the stock ticker information for the item. Element 705 may indicate when a firmware update is available. Element 706 may enable the user to trade to acquire the item either by using legal tender or one their previously acquired assets.

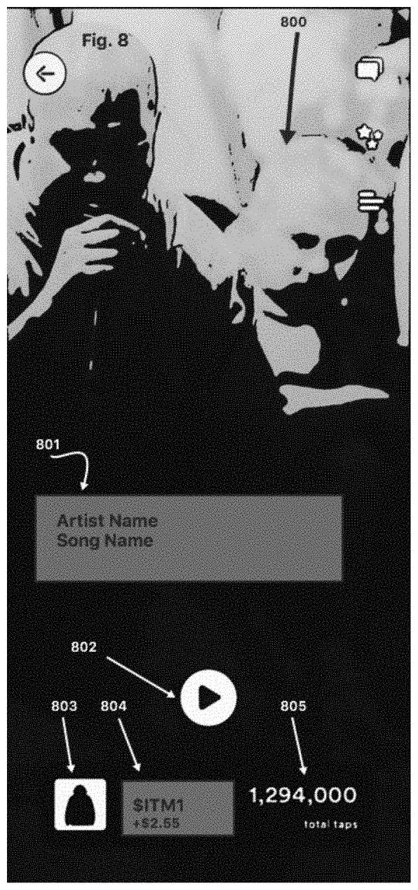

Referring to FIG. 8, 800 may illustrate using a mobile device and accessing a digital asset. In this example, the digital asset that is being accessed by the user is a music video, where the artist name and song name may be displayed in element 801. Element 802 is the play button that may enable a user to control playback of the music video. The apparel, its stock price and the number of taps received for that digital asset are also displayed. The apparel that is associated with the selected digital asset may be displayed in element 803, the stock price of the brand of the apparel may be displayed in element 804 and the number of taps received for the digital asset may be displayed in element 805.

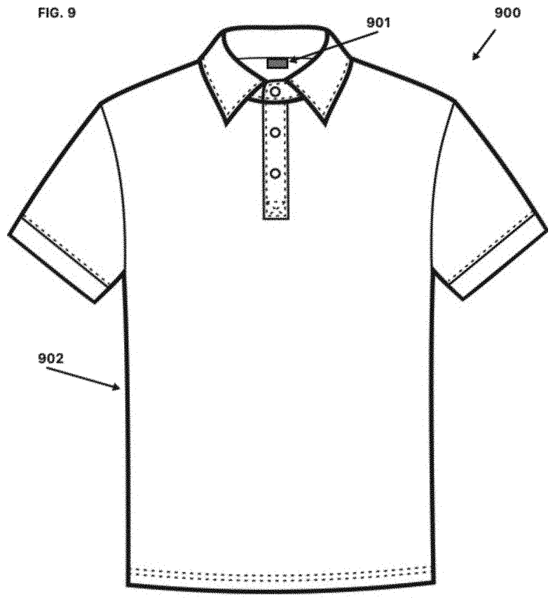

A further embodiment of the invention is displayed in FIG. 9. 900 includes an item of apparel 902 that may comprise a chip 901 embedded within a portion of the apparel where the chip may be assigned a blockchain ID defined as a chip ID. The chip 901 may be embedded in any portion of the apparel. In a preferred embodiment of the invention, the chip may be embedded in the tag of the item. However, in another embodiment of the invention, the chip may be embedded in the hem of the item or the breast or shoulder area. The chip 901 may be configured to communicate with a mobile device 102 that is connected to the Internet 103 or a global communications network and configured to create an account for linking a digital asset to chip 901 to thereby associate the digital asset to the apparel item 902. Mobile device 102 may be configured to scan the apparel item 902 to detect the presence of chip 901 and may be further configured to detect the chip ID assigned to the chip 901. The mobile device may be further configured to transmit the chip ID to server 104, where server 104 may be configured to validate the chip ID and transmit a confirmation of the authenticity of the chip ID to mobile device 102. Mobile device 102 may be configured to receive the confirmation from server 104 that the apparel is authentic where the detected chip ID is associated with an account of user 101. Mobile device 102 may be further configured to identify the digital asset associated with the detected chip ID and associate the digital asset with the account of user 101.

The various illustrative program modules and steps described in connection with the embodiments disclosed herein may be implemented as electronic hardware, computer software, or combinations of both. The various illustrative program modules and steps have been described generally in terms of their functionality. Whether the functionality is implemented as hardware or software depends in part upon the hardware constraints imposed on the system. Hardware and software may be interchangeable depending on such constraints. As examples, the various illustrative program modules and steps described in connection with the embodiments disclosed herein may be implemented or performed with an application specific integrated circuit (ASIC), a field programmable gate array (FPGA) or other programmable logic device, discrete gate or transistor logic, discrete hardware components, a conventional programmable software module and a processor, or any combination thereof designed to perform the functions described herein. The processor may be a microprocessor, CPU, controller, microcontroller, programmable logic device, array of logic elements, or state machine. The software module may reside in RAM memory, flash memory, ROM memory, EPROM memory, EEPROM memory, hard disk, a removable disk, a CD, DVD or any other form of storage medium known in the art. An exemplary processor may be coupled to the storage medium so as to read information from, and write information to, the storage medium. In the alternative, the storage medium may be integral to the processor.

In further embodiments, those skilled in the art will appreciate that the foregoing methods can be implemented by the execution of a program embodied on a computer readable medium. The medium may comprise, for example, RAM accessible by, or residing within the device. Whether contained in RAM, a diskette, or other secondary storage media, the program modules may be stored on a variety of machine-readable data storage media, such as a conventional “hard drive”, magnetic tape, electronic read-only memory (e.g., ROM or EEPROM), flash memory, an optical storage device (e.g., CD, DVD, digital optical tape), or other suitable data storage media.

While the present invention has been described above in terms of specific embodiments, it is to be understood that the invention is not limited to these disclosed embodiments. Many modifications and other embodiments of the invention will come to mind of those skilled in the art to which this invention pertains, and which are intended to be and are covered by both this disclosure and the appended claims. It is indeed intended that the scope of the invention should be determined by proper interpretation and construction of the appended claims and their legal equivalents, as understood by those of skill in the art relying upon the disclosure in this specification and the attached drawings.

What is claimed:

1. A method for associating a digital asset to apparel and said apparel to a user, wherein the apparel includes an embedded chip that is assigned a blockchain ID, and wherein a mobile device is used to create an account for linking the asset to the user, the method comprising:
scanning the apparel with the mobile device, wherein the mobile device detects the presence of the embedded chip and further detects the chip ID of the chip;
transmitting the chip ID to a server, wherein the server is configured to validate the chip ID and transmit a confirmation of the authenticity of the chip ID to the mobile device;
receiving the confirmation from the server, by the mobile device which indicates that the apparel is authentic;
associating the detected chip ID of the chip with the user's account;
determining the digital asset associated with the detected chip ID; and
associating the digital asset with the user's account.

2. The method of claim 1, wherein the digital asset associated with the chip is determined during the scan of the apparel by the mobile device, wherein the embedded chip transmits the digital asset to the mobile device.

3. The method of claim 1, wherein associating the detected chip ID of the chip with the user's account includes associating the chip ID with a social media account of the user.

4. The method of claim 1, wherein associating the detected chip ID of the chip with the user's account includes associating the chip ID with a state-issued identification of the user.

5. The method of claim 1, wherein the user utilizes the mobile device to access the digital asset linked to the user.

6. The method of claim 1, wherein the chip embedded in the apparel comprises a primary chip and secondary chip.

7. The method of claim 6, wherein the mobile device determines the apparel is damaged upon scanning when the mobile device does not detect a signal from at least one of the primary chip and the secondary chip.

8. The method of claim 7, further comprising utilizing the mobile device to delete the digital asset from the secondary chip.

9. The method of claim 6 wherein the secondary chip includes a codec for content; wherein the codec can be written and overwritten via an authorized user; and wherein the primary chip is configured for identification purposes and cannot be overwritten or edited.

10. The method of claim 8, wherein the secondary chip is preloaded with the digital asset.

11. The method of claim 10, further comprising using the mobile device to delete the digital asset from the apparel by overwriting the secondary chip with a null value upon a prompt from the user.

12. The method of claim 9 wherein the chip is security enabled.

13. The method of claim 7 further comprising performing an authorized over-the-air update of the secondary chip using the mobile device.

14. A method for associating a digital asset to apparel and said apparel to a user, where the apparel includes an embedded chip that is assigned a chip ID, and said user utilizes their user account on a mobile device for transferring the asset to a third party, the method comprising:
scanning the apparel with the mobile device, where the mobile device detects the presence of the embedded chip and further detects the chip ID of the chip;
transmitting the chip ID to a server, and further transmitting an indication to register the digital asset to a third party, and further transmitting the account ID of the third party;
reassociating the detected chip ID of the embedded chip with the third party account ID;
and associating the digital asset with the third party account.

15. A system providing an electronic marketplace for buying and selling digital assets where the digital assets are associated with apparel, the system comprising:
a digital wallet that stores digital assets and associates these digital assets with a user; and a server that forges a connection with the digital wallet, where the server is programmed to:
receive, over a computing network, a repository of digital assets owned by the user that are stored in the digital wallet;
where each digital asset is associated with a user account associated with the user and the apparel into which the digital asset is integrated; and
where the user is presented with an option to broadcast the digital asset for sale on the marketplace.

16. The system of claim 15, where the user has the option to sell the digital asset attached to the apparel separately from the apparel on the marketplace.

17. An apparel item comprising:
a chip embedded within a portion of the apparel;
wherein the chip is assigned a blockchain ID defined as a chip ID;
wherein the chip is configured to communicate with a mobile device that is connected to a global communications network and configured to create an account for linking a digital asset to the chip to thereby associate the digital asset to the apparel item;
wherein the mobile device is configured to scan the apparel item to detect the presence of the chip;
wherein the mobile device is configured to detect the chip ID assigned to the chip;
wherein the mobile device is configured to transmit the chip ID to a server;
wherein the server is configured to validate the chip ID and transmit a confirmation of the authenticity of the chip ID to the mobile device;
wherein the mobile device is configured to receive the confirmation from the server that the apparel is authentic;
wherein the detected chip ID is associated with an account of the user;
identifying the digital asset associated with the detected chip ID using the mobile device; and
associating the digital asset with the user's account.

18. The apparel item of claim 17 wherein the chip further comprises a primary chip and a secondary chip.

19. The apparel item of claim 18 wherein the server determines the chip is damaged when the mobile device performs a scan of the chip and does not detect a signal from at least one of the primary chip and the secondary chip.

20. The apparel item of claim 18 wherein the secondary chip includes a codec for content; wherein the codec can be written and overwritten; and wherein the primary chip is configured for identification purposes and cannot be overwritten or edited.
